(19) United States
(12) Patent Application Publication
(10) Pub. No.: US 2023/0405892 A1
(43) Pub. Date: Dec. 21, 2023

(54) MOLD CLAMPING DEVICE AND INJECTION MOLDING MACHINE

(71) Applicant: THE JAPAN STEEL WORKS, LTD., Tokyo (JP)

(72) Inventor: Souma MITANI, Tokyo (JP)

(73) Assignee: THE JAPAN STEEL WORKS, LTD., Tokyo (JP)

(21) Appl. No.: 18/333,625

(22) Filed: Jun. 13, 2023

(30) Foreign Application Priority Data
Jun. 15, 2022 (JP) 2022-096257

(51) Int. Cl. B29C 45/17

(52) U.S. Cl. CPC B29C 45/1744

(57) ABSTRACT

A mold clamping device includes a fixed platen fixed on the bed, a movable platen provided slidably with respect to the bed, a rotary platen provided on the movable platen, and a rotary platen support configured to rotatably support the rotary platen. A rail is laid on the bed, and the rotary platen support is provided with a rotary platen-side slider which is slidable while being guided by the rail.

### CROSS-REFERENCE TO RELATED APPLICATIONS

This application is based on and claims priority under 35 USC 119 from Japanese Patent Application No. 2022-096257 filed on Jun. 15, 2022, the entire content of which is incorporated herein by reference.

### TECHNICAL FIELD

The present disclosure relates to a mold clamping device in which a rotary platen is provided on a movable platen, and an injection molding machine.

### BACKGROUND

A mold clamping device provided in an injection molding machine includes a fixed platen and a movable platen that is opened and closed with respect to the fixed platen. For example, as disclosed in JP2009-45939A, there is a type of injection molding machine in which a rotary platen is provided on a movable platen. In such an injection molding machine, a plurality of rotary-side molds are provided on the rotary platen, and every time the molds are opened and closed, a rotational position of the rotary platen is changed to perform mold clamping. Thus, the rotary-side molds to be clamped are changed with respect to a fixed-side mold provided on the fixed platen. A molded product can be efficiently molded while exchanging the plurality of rotary-side molds.

### SUMMARY

The movable platen is provided slidably with respect to a bed, and is slidable horizontally toward the fixed platen. The rotary platen is rotatably provided on a surface of the movable platen on a fixed platen side. Thus, a moment acts on the movable platen or the rotary platen in a direction in which the movable platen or the rotary platen tilts toward the fixed platen side due to a weight of the rotary platen. Further, the rotary platen is provided with metal molds, and the moment also acts due to weights of the metal molds. The movable platen is guided by, for example, a tie bar or the like, or is guided by another guide mechanism to prevent from tilting. However, the rotary platen is merely rotatably supported with respect to the movable platen. Thus, due to the action of the moment, deflection in a tilt direction of the rotary platen is generated. Accordingly, the mold clamping accuracy may be affected when the mold is clamped.

Illustrative aspects of the present disclosure propose a mold clamping device that prevents a rotary platen from being deflected in a tilt direction.

Other problems and novel features will become apparent from description of the present description and the accompanying drawings.

One illustrative aspect of the present disclosure provides a mold clamping device including a fixed platen fixed on a bed, a movable platen provided slidably with respect to the bed, a rotary platen provided on the movable platen, and a rotary platen support configured to rotatably support the rotary platen. A rail is laid on the bed, and the rotary platen support is provided with a rotary platen-side slider that is slidable while being guided by the rail.

According to the present disclosure, deflection in the tilt direction of the rotary platen can be prevented.

### BRIEF DESCRIPTION OF DRAWINGS

FIG. 1 is a side view of an injection molding machine according to an illustrative embodiment.

FIG. 2 is a front view showing a rotary platen and a part of a mold clamping device according to the present illustrative embodiment.

FIG. 3 is a perspective view showing a cross roller bearing provided between a fixed platen and the rotary platen in a partial cross section.

FIG. 4 is a side view showing a part of the mold clamping device according to the present illustrative embodiment.

FIG. 5A is a side view showing a part of a mold clamping device according to Modification 1 of the present illustrative embodiment.

FIG. 5B is a side view showing a part of a mold clamping device according to Modification 2 of the present illustrative embodiment.

FIG. 6A is a front view showing a rotary platen and a part of a mold clamping device according to Modification 3 of the present illustrative embodiment.

FIG. 6B is a side view showing a rotary platen and a part of a mold clamping device according to Modification 3 of the present illustrative embodiment.

FIG. 6C is a front view showing a rotary platen and a part of a mold clamping device according to Modification 4 of the present illustrative embodiment.

### DETAILED DESCRIPTION

Hereinafter, illustrative embodiments will be described in detail with reference to the drawings. The present invention is not limited to the following illustrative embodiment. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

The present illustrative embodiment will be described.

### {Injection Molding Machine}

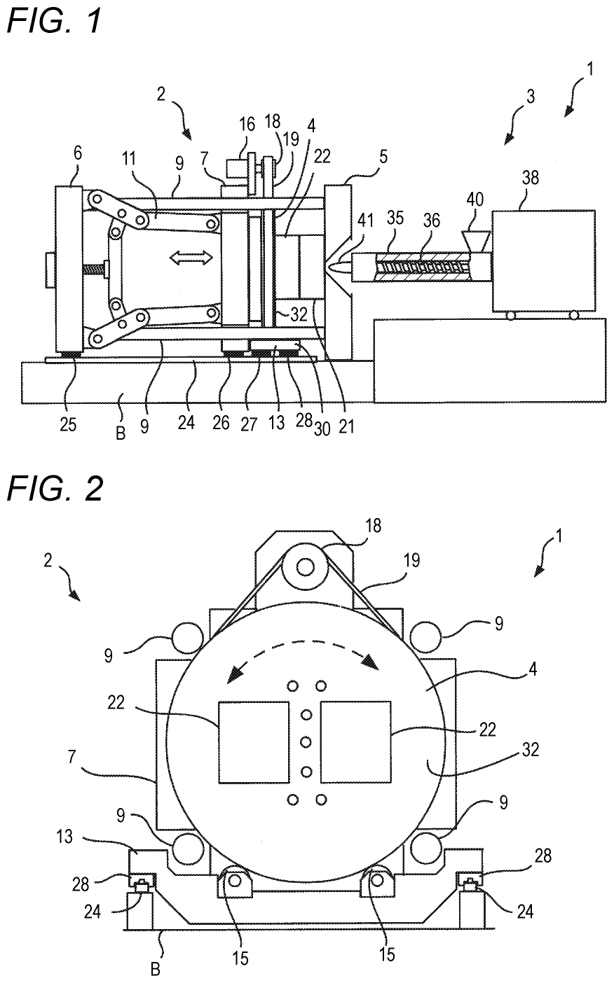

As shown in FIG. 1, an injection molding machine 1 according to the present illustrative embodiment roughly includes a mold clamping device 2 configured to clamp a mold, and an injection device 3 configured to melt and inject an injected material.

{Mold Clamping Device}

The mold clamping device 2 includes a fixed platen 5 fixed on a bed B, a mold clamping housing 6 slidable on the bed B, a movable platen 7 slidable on the bed B in the same manner, and a rotary platen 4 to be described below. The fixed platen 5 and the mold clamping housing 6 are connected by a plurality of, for example, four tie bars 9, 9 . . . . The movable platen 7 is slidable between the fixed platen 5 and the mold clamping housing 6. A mold clamping mechanism 11 is provided between the mold clamping housing 6 and the movable platen 7. The mold clamping mechanism 11 may be implemented by a direct pressure type mold clamping mechanism, that is, a mold clamping cylinder. In the present illustrative embodiment, the mold clamping mechanism 11 is implemented by a toggle mechanism.

{Rotary Platen}

The mold clamping device 2 according to the present illustrative embodiment includes a rotary platen support 13. The rotary platen 4 according to the present illustrative embodiment is supported by the rotary platen support 13. That is, the rotary platen 4 is provided rotatably with respect to the movable platen 7, and is supported by the rotary platen support 13. As shown in FIG. 2, the rotary platen support 13 includes two rollers 15, 15, and an outer peripheral surface of the rotary platen 4 is placed on the rollers 15, 15. The rotary platen support 13 is supported by the bed B via a guide mechanism, which will be described later in detail. Accordingly, a weight of the rotary platen 4 acts on the bed B via the rotary platen support 13.

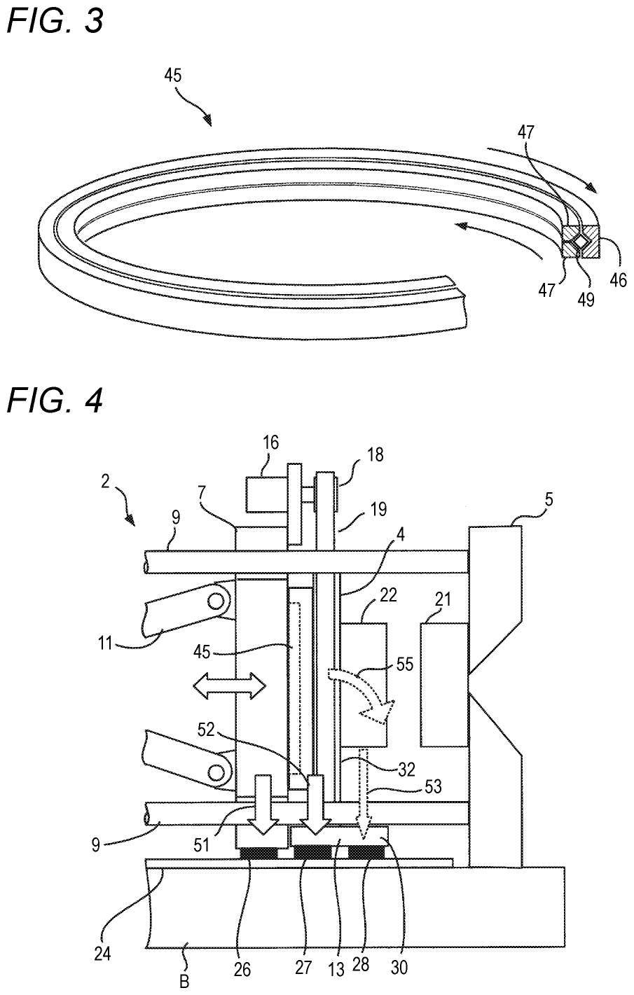

Although it has been described that the rotary platen 4 is rotatably provided with respect to the movable platen 7, a cross roller bearing 45 shown in FIG. 3 is provided between the movable platen 7 and the rotary platen 4. The cross roller bearing 45 includes an outer ring 46 disposed on an outer side, a pair of inner rings 47, 47 disposed on an inner side, and a plurality of rollers 49, 49, . . . inserted between the outer ring 46 and the inner rings 47, 47. The outer ring 46 and the inner rings 47, 47 rotate relatively smoothly. Since the rotary platen 4 (see FIG. 1) is connected to the movable platen 7 by the cross roller bearing 45, the rotary platen 4 is rotatable smoothly.

As shown in FIG. 1, a drive motor 16 is provided on the movable platen 7, and a pulley 18 is provided on the drive motor 16. A belt 19 is wound around the pulley 18 and the rotary platen 4. Therefore, when the drive motor 16 is driven, the rotary platen 4 rotates.

In the mold clamping device 2 configured as described above, as shown in FIGS. 1 and 2, a fixed-side mold 21 is attached to the fixed platen 5, and two rotary-side molds 22, 22 are provided on the rotary platen 4. One of the two rotary-side molds 22, 22 is aligned with the fixed-side mold 21 according to a rotational position of the rotary platen 4. When the mold clamping mechanism 11 is driven, the fixed-side mold 21 and one of the rotary-side molds 22 aligned therewith are opened and closed.

{Guide Mechanism}

The mold clamping device 2 according to the present illustrative embodiment is characterized in that a guide mechanism is provided. This will be described. As shown in FIGS. 1 and 2, the guide mechanism includes two rails 24, 24 laid on the bed B, and a plurality of sets of sliders 25, 26, 27, 28 slidably provided on the rails 24, 24. First, the mold clamping housing 6 is provided with the set of mold clamping housing-side sliders 25. Further, the movable platen 7 is also provided with the set of movable platen-side sliders 26. Accordingly, the mold clamping housing 6 and the movable platen 7 are smoothly slidable on the rails 24, 24.

The rotary platen support 13 is also provided with the sliders 27, 28, and the rotary platen support 13 is provided with two sets of sliders, that is, the first rotary platen-side sliders 27 and the second rotary platen-side sliders 28. As shown in FIG. 1, a protrusion portion 30 protruding toward the rotary-side molds 22 is formed on a part of the rotary platen support 13. When viewed from a horizontal direction orthogonal to the rails 24, 24, that is, when viewed from a direction shown in FIG. 1, the first rotary platen-side sliders 27 are disposed below a center of gravity of the rotary platen 4. On the other hand, the second rotary platen-side sliders 28 are provided on the protrusion portion 30. More specifically, the second rotary platen-side sliders 28 are disposed at positions closer to a fixed platen 5 side with respect to a mold mounting surface 32 of the rotary platen 4. Accordingly, the second rotary platen-side sliders 28 are disposed below centers of gravity of the rotary-side molds 22, 22.

{Injection Device}

The injection device 3 includes a heating cylinder 35, a screw 36 inserted in the heating cylinder 35, and a screw drive device 38 configured to drive the screw 36. The heating cylinder 35 is provided with a hopper 40 at a vicinity of a rear end thereof. An injection nozzle 41 at a tip end of the heating cylinder 35.

{Operation}

The operation of the mold clamping device 2 according to the present illustrative embodiment will be described. A case where the mold clamping device 2 is in a mold open state as shown in FIG. 4 is considered. A weight of the movable platen 7 acts on the movable platen-side sliders 26 as indicated by an arrow 51, a weight of the rotary platen 4 acts on the first rotary platen-side sliders 27 via the rotary platen support 13 as indicated by an arrow 52, and the movable platen 7 and the rotary platen 4 are supported. Weights of the rotary-side molds 22 indirectly act on and are supported by the second rotary platen-side sliders 28 as indicated by a dotted arrow 53. Thus, the weights of the rotary platen 4 and the rotary-side molds 22 do not act on the movable platen 7, or the degree of acting is small. Accordingly, deflection in a tilt direction of the rotary platen 4 with respect to the movable platen 7 does not occur. Thus, the rotary-side mold 22 and the fixed-side mold 21 are accurately aligned, and the molds are accurately clamped when the mold clamping device 2 is driven to clamp the molds.

Here, consider a case where the rotary platen support 13 is not provided. When the rotary platen support 13 is not provided, a moment indicated by an arrow 55 acts on the rotary platen 4 due to the weights of the rotary platen 4 and the rotary-side molds 22. Due to this moment, deflection in the tilt direction relative to the movable platen 7 is generated in the rotary platen 4. Thus, the rotary-side mold 22 is slightly tilted and alignment with the fixed-side mold 21 is deteriorated. When the mold clamping device 2 is driven to perform mold clamping, sufficient accuracy cannot be obtained. On the other hand, the mold clamping device 2 according to the present illustrative embodiment includes the rotary platen support 13, and the rotary platen support 13 is slidable with respect to the bed B via the guide mechanism. Accordingly, the moment indicated by an arrow 55 is hardly generated, and the above-described effect is obtained.

### Modification 1

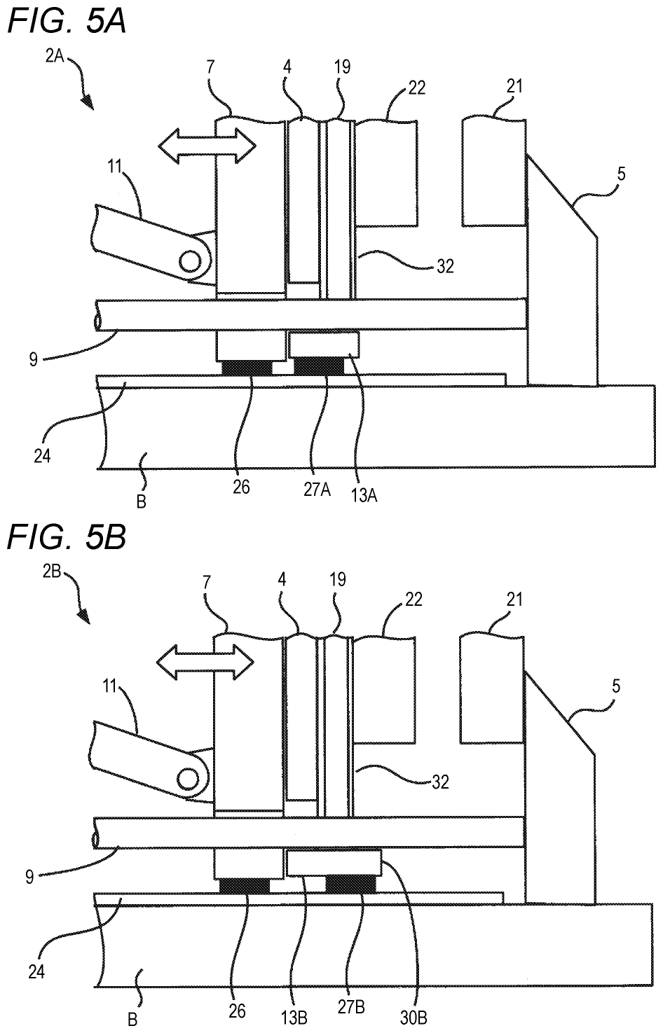

Modification 1 of the mold clamping device 2 according to the present illustrative embodiment will be described. FIG. 5A shows a mold clamping device 2A according to Modification 1. Regarding a configuration of the mold clamping device 2A, parts that are not shown in FIG. 5A are the same as those of the mold clamping device 2 shown in FIGS. 1 and 2, and the description thereof is omitted. In the mold clamping device 2A according to Modification 1, a lower portion of the rotary platen support 13A does not protrude toward the rotary-side molds 22. That is, the protrusion portion 30 as shown in FIG. 4 is not provided. Although the protrusion portion 30 is not provided, the rotary platen support 13A is supported on the rails 24 by rotary platen-side sliders 27A, as shown in FIG. 5A. Accordingly, in the mold clamping device 2A according to Modification 1, the weight of the rotary platen 4 also hardly acts on the movable platen 7. Alternatively, the effect may be slight. That is, in the mold clamping device 2A according to Modification 1, deflection in the tilt direction of the rotary platen 4 is also unlikely to occur.

### Modification 2

Modification 2 of the mold clamping device 2 according to the present illustrative embodiment will be described. FIG. 5B shows a mold clamping device 2B according to Modification 2. Regarding a configuration of the mold clamping device 2B, parts that are not shown in FIG. 5B are the same as those of the mold clamping device 2 shown in FIGS. 1 and 2, and the description thereof is omitted. In the mold clamping device 2B according to Modification 2, a protrusion portion 30B is formed on a rotary platen support 13B. However, the degree of protrusion is relatively smaller than that of the first illustrative embodiment shown in FIG. 3. Rotary platen-side sliders 27B provided on the rotary platen support 13B are not disposed at positions protruding beyond the rotary-side molds 22 from the mold mounting surface 32. That is, in the mold clamping device 2B according to Modification 2, the rotary platen-side sliders 27B are provided at an intermediate position between the rotary platen 4 and the rotary-side molds 22. In other words, the rotary platen-side sliders 27B are disposed at a center of gravity of a combination of the rotary platen 4 and the rotary-side molds 22. In Modification 2, deflection in the tilt direction of the rotary platen 4 is also unlikely to occur.

### Modification 3

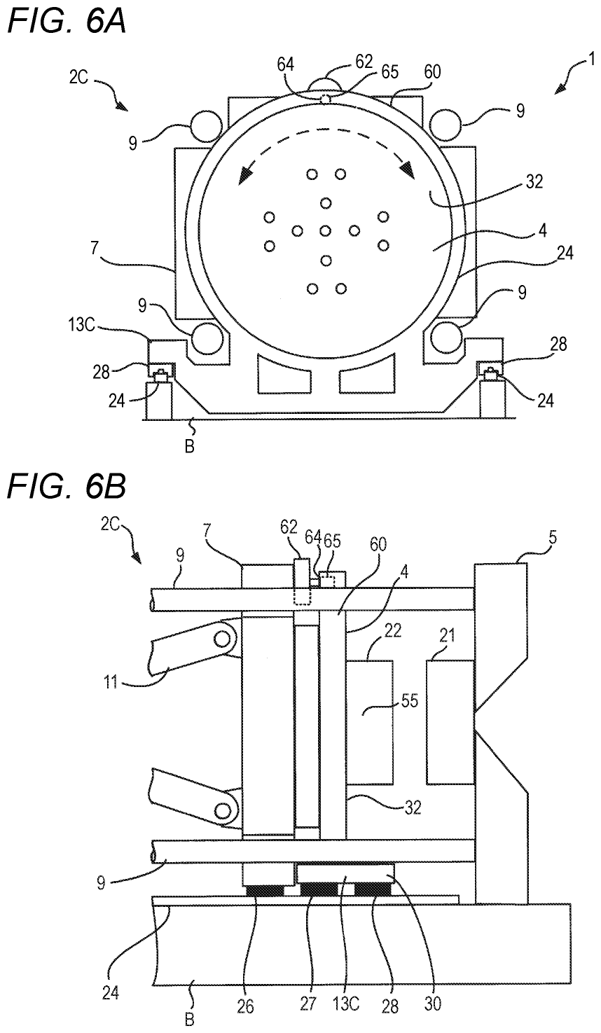

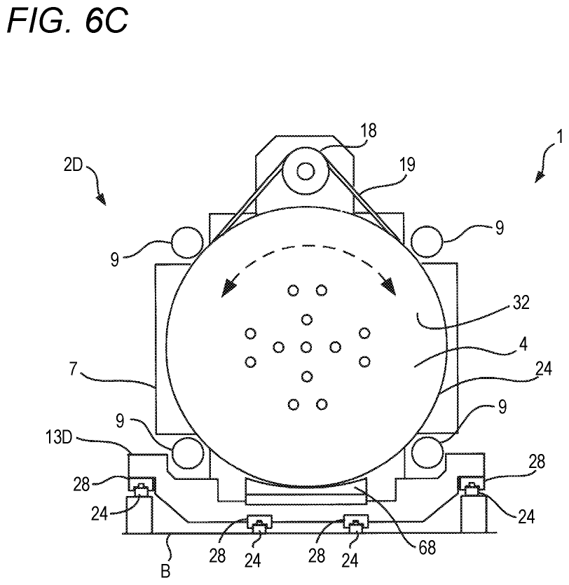

Modification 3 of the mold clamping device 2 according to the present illustrative embodiment will be described. FIGS. 6A and 6B show a mold clamping device 2C according to Modification 3. Regarding a configuration of the mold clamping device 2C, parts that are not shown in FIGS. 6A and 6B are the same as those of the mold clamping device 2 shown in FIGS. 1 and 2, and the description thereof is omitted. In the mold clamping device 2C according to Modification 3, as shown in FIG. 6A, an annular portion 60 that supports the rotary platen 4 by an inner peripheral surface thereof is formed on a rotary platen support 13C. That is, the rotary platen 4 rotates while being in contact with the inner peripheral surface of the annular portion 60. Incidentally, most of the weight of the rotary platen 4 acts on a lower part of the inner peripheral surface of the annular portion 60.

A hole 64 is formed in the annular portion 60 from a back surface side as viewed in FIG. 6A. A roller 65 is inserted into the hole 64 from the back surface side. As shown in FIG. 6B, the movable platen 7 is provided with a motor 62, and the roller 65 is rotated by the motor 62. A rubber is provided on an outer peripheral surface of the roller 65 and is in contact with the outer peripheral surface of the rotary platen 4. Accordingly, when the motor 62 is driven, the roller 65 rotates, so that the rotary platen 4 can be rotated. As well in Modification 3, the weight of the rotary platen 4 is supported by the rotary platen support 13C, and the rotary platen support 13C is supported by the second rotary platen-side sliders 28.

### Modification 4

Modification 4 of the mold clamping device 2 according to the present illustrative embodiment will be described. FIG. 6C shows a mold clamping device 2D according to Modification 4. Regarding a configuration of the mold clamping device 2D, parts that are not shown in FIG. 6C are the same as those of the mold clamping device 2 shown in FIGS. 1 and 2, and the description thereof is omitted. In the mold clamping device 2D according to Modification 4, a rotary platen support 13D is provided with a sliding bearing structure 68 that supports the rotary platen 4 from below. The sliding bearing structure 68 supports the outer peripheral surface of the rotary platen 4 in a slidable manner. In the mold clamping device 2D according to Modification 4, only one sliding bearing structure 68 is provided. Alternatively, two or more sliding bearing structures 68 may be provided.

The mold clamping device 2D according to Modification 4 is also characterized in that four rails 24, 24 . . . are provided. With respect to the four rails 24, 24 . . . , four second rotary platen-side sliders 28, 28 . . . are also provided on the rotary platen support 13D. As can be easily understood from the mold clamping device 2D according to Modification 4, the number of the rails 24, 24 . . . and the number of the sliders 25, 26 . . . are not limited, and the mold clamping device 2 according to the present illustrative embodiment (see FIGS. 1 and 2) can be freely modified.

Although the invention made by the present inventor has been specifically described above based on the illustrative embodiment, it is needless to say that the present invention is not limited to the illustrative embodiment described above, and various modifications can be made without departing from the scope of the invention. A plurality of examples described above may be implemented in combination as appropriate.

What is claimed is:

1. A mold clamping device comprising:
a fixed platen fixed on a bed;
a movable platen provided slidably with respect to the bed;
a rotary platen provided on the movable platen; and
a rotary platen support configured to rotatably support the rotary platen,
wherein a rail is laid on the bed, and
wherein the rotary platen support is provided with a rotary platen-side slider that is slidable while being guided by the rail.

2. The mold clamping device according to claim 1, wherein the movable platen is provided with a movable platen-side slider that is slidable while being guided by the rail.

3. The mold clamping device according to claim 1, wherein the rotary platen support is provided with two or more sets of the rotary platen-side sliders.

4. The mold clamping device according to claim 3,
wherein a part of a slider attachment portion of the rotary platen support is a protrusion portion that protrudes from a mold mounting surface of the rotary platen toward the fixed platen, the rotary platen-side sliders being provided on the slider attachment portion, and
wherein at least one set of the rotary platen-side sliders is disposed on the protrusion portion.

5. The mold clamping device according to claim 1, wherein the rotary platen is rotatably provided on the movable platen via a cross roller bearing.

6. An injection molding machine comprising:
a mold clamping device configured to clamp a mold; and
an injection device configured to melt an injected material and to inject the melted material into the mold, wherein the mold clamping device comprises:
a fixed platen fixed on a bed;
a movable platen provided slidably with respect to the bed;
a rotary platen provided on the movable platen; and
a rotary platen support configured to rotatably support the rotary platen, wherein a rail is laid on the bed, and
wherein the rotary platen support is provided with a rotary platen-side slider that is slidable while being guided by the rail.

7. The injection molding machine according to claim 6, wherein the movable platen is provided with a movable platen-side slider that is slidable while being guided by the rail.

8. The injection molding machine according to claim 6, wherein the rotary platen support is provided with two or more sets of the rotary platen-side sliders.

9. The injection molding machine according to claim 8,
wherein a part of a slider attachment portion of the rotary platen support is a protrusion portion that protrudes from a mold mounting surface of the rotary platen toward the fixed platen, the rotary platen-side sliders being provided on the slider attachment portion, and
wherein at least one set of the rotary platen-side sliders is disposed on the protrusion portion.

10. The injection molding machine according to claim 6, wherein the rotary platen is rotatably provided on the movable platen via a cross roller bearing.
